(19) United States
(12) Patent Application Publication
(10) Pub. No.: US 2016/0309804 A1
(43) Pub. Date: Oct. 27, 2016

(54) GARMENT FOR CARRYING AN ANIMAL

(71) Applicant: Paulette Cohen, Beverly Hills, CA (US)

(72) Inventor: Paulette Cohen, Beverly Hills, CA (US)

(21) Appl. No.: 14/697,257

(22) Filed: Apr. 27, 2015

(51) Int. Cl. A41D 3/00; A61D 3/00

(52) U.S. Cl. CPC A41D 3/00; A61D 3/00

(57) ABSTRACT

An apparatus for carrying an animal is provided herein. The apparatus has a wearable garment having at least a first connector element and a second connector element attached thereto and a pouch having at least a third connector element and a fourth connector element attached to a first and a second support portion, each of the third and the fourth connector elements configured for releasable connection to the first and second connector elements of the garment. The pouch has an internal pocket and a bottom aperture.

### CROSS-REFERENCE TO RELATED APPLICATIONS

This application claims the benefit of U.S. Provisional Application No. 60/123,456, filed May 1, 2014.

### BACKGROUND

This application relates generally to an apparatus for carrying an animal. More particularly, this application is directed towards a shirt and pouch configured for connection to the other, the pouch configured to carry an animal, such as a small dog or other domesticated house pet.

Sweatshirts, and zip-up hooded sweatshirts, have been the preferred choice as a comfortable outer garments for many years. These types of garments are preferred because they are typically warm, slightly oversized by design and comfortable to wear. As such, they are typically used as “throw on garments”, meaning people typically wear them to go on errands, walking pets, or on weekends when a more causal look is preferred.

Zip up sweatshirts typically feature oversized pockets on either side of the front of the garment. The purpose of the pockets are to carry personal items as well as to serve as a place to keep the wearer's hands warm. Hooded sweatshirts that do not have a zipper often have a large pouch on the front with openings on either side to allow for the wearer to insert personal items as well as a user's hands. However, both of these pocket and pouch designs serve very limited purposes, particularly when looking at the needs of wearers today. Critically, these pockets and pouches are not configured to carry a small dog.

According to the Humane Society, there are approximately 84 million dogs owned in the US. In terms of size, U.S. pet owners are increasingly favoring smaller dogs, whose share of dog-owning households rose between 2000 and 2010, according to recent findings by market research publisher Packaged Facts on the U.S. pet industry. For the first time in 2010, there were as many households in the U.S. with small dogs as there were with large dogs, and far fewer medium dog households. A recent pet owner survey indicates that a higher percentage of U.S. households have small dogs (under 25 lbs.) than medium dogs (25-40 lbs.) or large dogs (40+ lbs.), with the figures at 48%, 32%, and 36%, respectively. It's very likely that the shift to smaller dogs will continue in the years ahead.

The market is saturated with small dog carriers that take the look of a purse or hand-bag. Clearly, these require the user to carry the hand-bag, which is inconvenient, particularly when the user requires a second hand bag to carry his or her personal items.

Other carriers take the form of an “over the shoulder” bag or satchel. These bags suffer from similar draw-backs of the handbag carriers, in that users must maintain control of bags using a hand. Furthermore, these bags lack comfort due to having all weight on a single shoulder.

There is a need for a convenient, comfortable, and safe way to carry a small dog.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a perspective view of the shirt together with the wearable pouch in accordance with an embodiment of the present invention;

FIG. 2 is a perspective view of the pouch in accordance with an embodiment of the present invention;

FIG. 3 is an exploded view of the garment and pouch in accordance with an embodiment of the present;

FIG. 4 is a front view of the garment and pouch in accordance with an embodiment of the present invention;

FIG. 5 is a front view of the harness that a user wears with pouch in accordance with an embodiment of the present invention;

Unless otherwise indicated illustrations in the figures are not necessarily drawn to scale.

### SUMMARY OF THE INVENTION

The following summary of the invention is provided in order to provide a basic understanding of some aspects and features of the invention. This summary is not an extensive overview of the invention and as such it not intended to particularly identify key or critical elements of the invention or to delineate the scope of the invention. Its sole purpose is to present some concepts of the invention in a simplified form as a prelude to the more detailed description that is presented below.

Various embodiments of the subject invention provide an apparatus for carrying an animal, the apparatus comprising a wearable garment having at least a first connector element and a second connector element attached thereto, a pouch having at least a third connector element and a fourth connector element attached to a first and a second support portion, each of the third and the fourth connector elements configured for releasable connection to the first and second connector elements of the garment, wherein the pouch comprises a internal pocket and a bottom aperture.

Various embodiment of the invention provide a harness for carrying an animal, the harness comprising a support structure having a first and second strap, each of the first and the second strap having connectors at each end, and a pouch having at least two support portions having respective connectors at each end, wherein the support stricture connectors are releasably connected to respective ones of the support structure, wherein the pouch comprises a internal pocket and a bottom aperture.

In order to eliminate the defects in the prior art, an object of the present invention is to provide shirt and pouch, which can be used comfortably without pain or feeling of physical disorder during the use.

Other features, advantages, and aspects of the present invention will become more apparent and be more readily understood from the following detailed description, which should be read in conjunction with the accompanying drawings.

### DETAILED DESCRIPTION OF THE INVENTION

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. For example, while sweatshirts (some with hoods) are primarily referred to herein, it will be appreciated that other garments are applicable to embodiments of the present invention. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules.

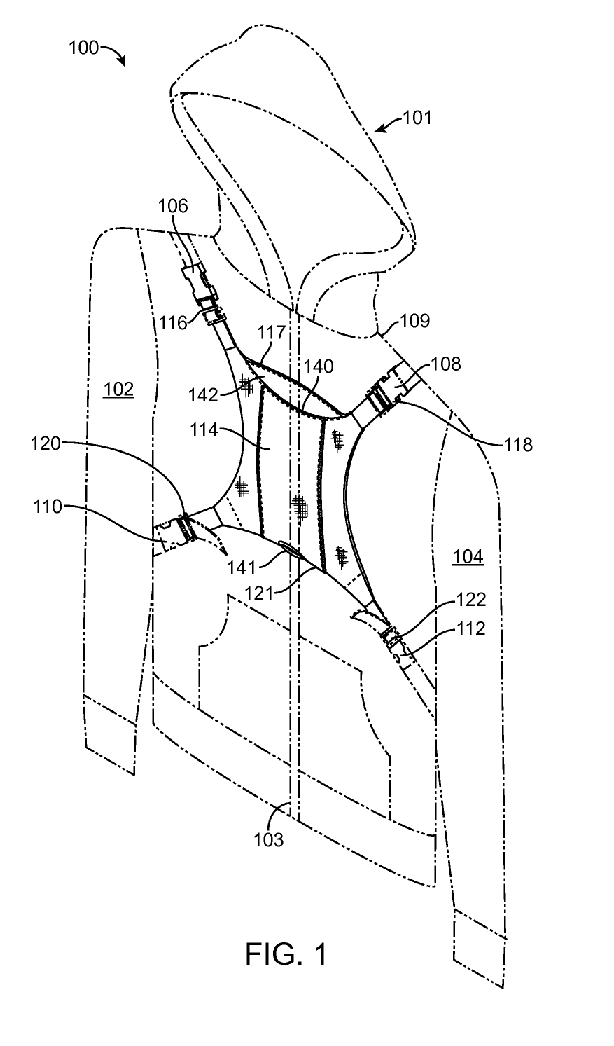

Referring now to FIG. 1, a garment having a pouch is shown generally at 100. The garment 100, in this embodiment, is a shirt 101 (e.g., hooded sweatshirt). The garment 100 may comprise, as is known in the art, first and second sleeves 102 and 104, and a front zipper 103. In this embodiment, the sweatshirt 101 is shown with broken lines such that the pouch 114, which is disposed interiorly, is viewable.

On an interior of the shirt 101, there is first and second 106 and 108 connectors, or fastening elements. The connectors 106 and 108 may comprise male and female portions that may be clipped, snapped, press fit or fit by interference such that they are easily connectable and separable. The first and second connectors 106 and 108 are disposed on the shoulder portion 109 of the interior of the garment. In this embodiment, each connector 106 and 108 is a female portion.

Third and fourth fastening elements, or connectors, 110 and 112 are disposed on the lower portion of the interior of the garment. Like connectors 106 and 108, the lower portion connectors 110 and 112 they are disposed on an interior of the garment proximate the user's rib cage, and may comprise male and female portions that may clipped, snapped, press fit or fit by interference such that they are easily connectable and separable. In this embodiment, each connector 110 and 112 is a female portion.

Referring still to FIG. 1, the pouch 114 is formed of an elastomeric material, in an exemplary embodiment of the present invention. The pouch 114 is configured with an internal space 140 or first aperture, and a second aperture 141 sized for the tail of a small animal. The pouch 114 is provided with connector 116 and 118 on the top 117 of the pouch 114 and two connectors 120 and 122 on the lower portion 121, these connectors being configured to mate with the connectors 106, 108, 110 and 112, respectively. The connectors may be coupled and decoupled through the use of, in this exemplary embodiment, three pronged clip fasteners. In other optional embodiments, the coupling and decoupling may occur via Velcro, clasps, buttons, male and female screw threads and like. In another optional embodiment, the pouch and the garment may be a single structure or element.

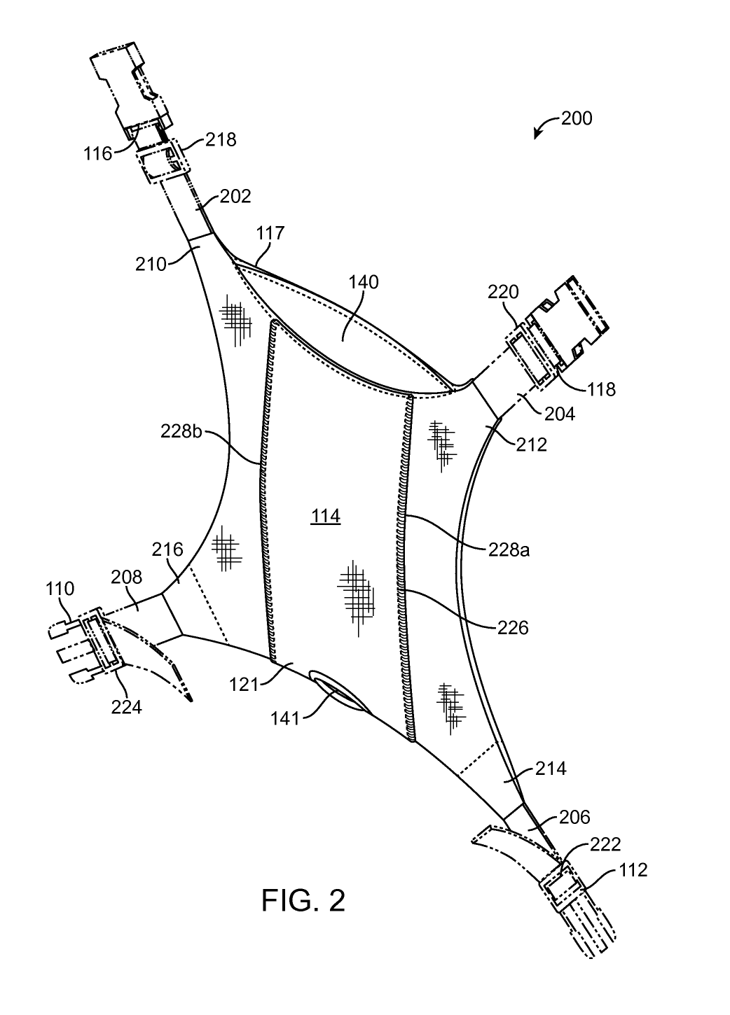

With reference to FIG. 2, a perspective view of the pouch is shown generally at 200. Like in FIG. 1, the pouch 114 is provided with connector 116 and 118 on the top 117 of the pouch 114 and two connectors 120 and 122 on the lower portion 121 these connectors being configured to mate with the connectors 106, 108, 110 and 112 of the garment of FIG. 1. As shown in this exemplary embodiment, the pouch further comprises straps 202, 204, 206 and 208. The straps are connected, at one end, to the pouch 114 on each of its four corners 210, 212, 214, and 216, on one end of the strap. On the opposite end of the straps 202, 204, 206 and 208, the straps are attached to the connectors 106, 108, 110 and 112. Each of the straps 202, 204, 206 and 208 are fitted with adjustable slides 218, 220, 222 and 224. The adjustable slides operate to shorten or lengthen each of the straps such that a user can alter the length of each of the straps. The adjustable slides 218, 220, 222 and 224 may comprise any adjustable buckle strap or analogous adjustable slide.

The pouch 114 as shown, may comprise a hinged flap 226, and an additional openings 228a and 228b, the flap and openings are configured to allow easy and comfortable ingress and egress for a small animal, and the flap configured to ensure the animals stays safe and cool on warm days, or, when closed, warm on cool days. Also, the openings 228a and 228b are sized such that the animal does not unintentionally fall out of the pouch 114. Optionally, pads (not shown) may be disposed in the shoulders of the garment, attached to either the garment itself, or to the pouch.

In optional embodiments, the pouch is constructed of a material that of 95% cotton, and 5% spandex such that it is pliable and stretchable to increase user and animal comfort.

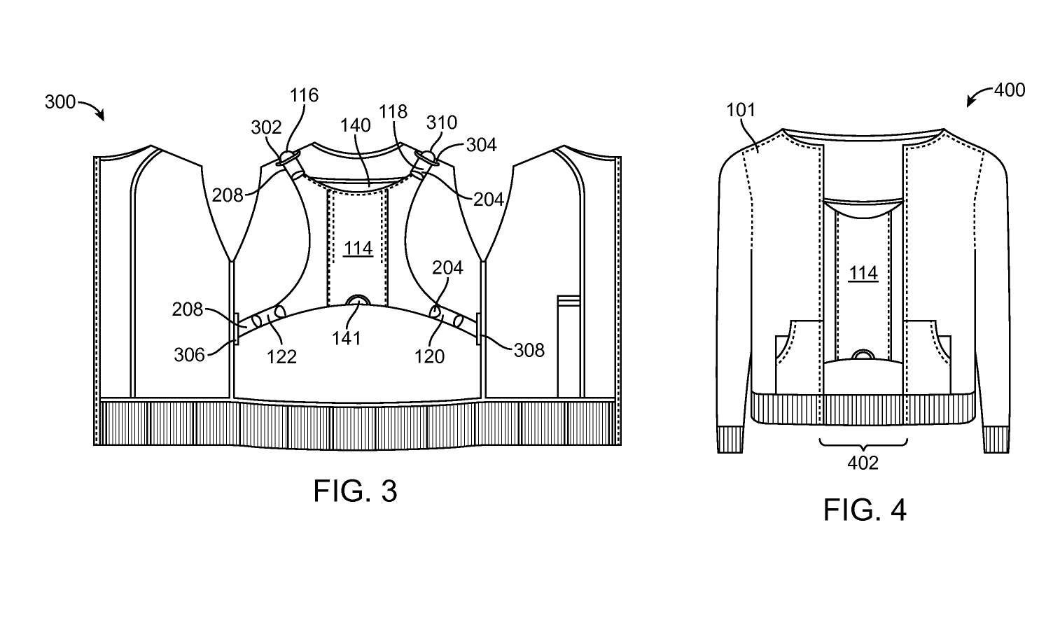

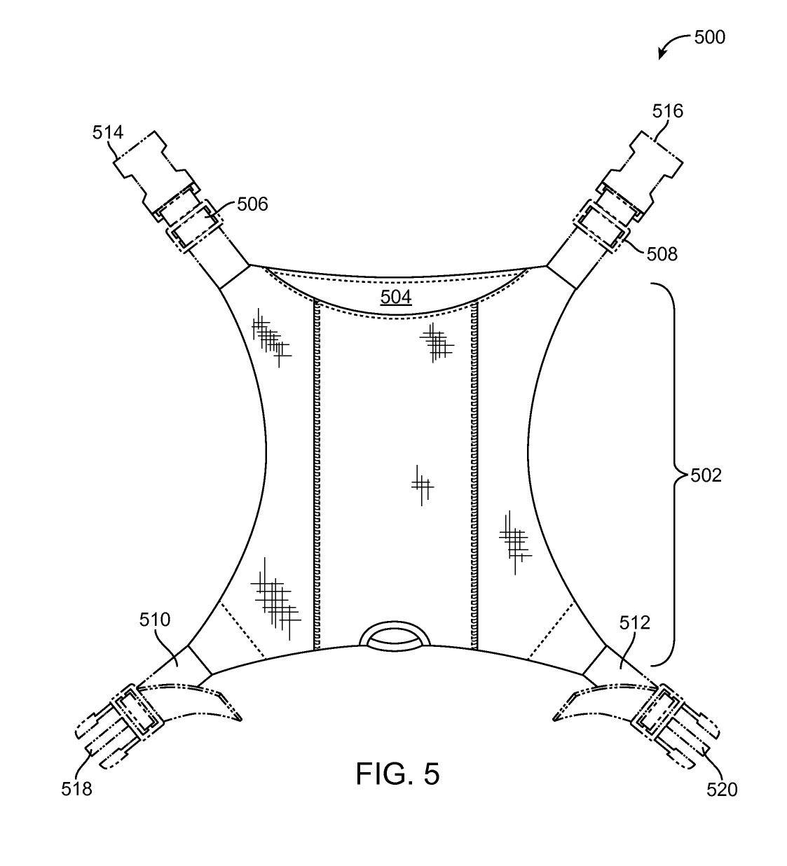

Referring now to FIG. 3, an optional embodiment of the present invention is shown generally at 300. In this embodiment, the pouch 114 is connected to a harness 310, which is described in further detail in FIG. 5, and the harness 310 is connected to garment via loops 302, 304, 306 and 306. In this way, the harness can be worn without the garment 101. Operationally however, the harness 310 and the garment 101 are coupled so as to provide a comfortable and secure fit for the user and animal.

In this optional embodiment, like in FIG. 1 and FIG. 2, the pouch 114 is configured with an internal space 140 or first aperture, and a second aperture 141 sized for the tail of a small animal. The pouch 114 is provided with connector 116 and 118 on the top 117 of the pouch 114 and two connector 120 and 122 on the lower portion 121 of the pouch 114. Like in FIG. 2, the pouch further comprises straps 202, 204, 206 and 208.

However, in this embodiment, the connectors 116 and 118 (e.g., male connectors) do not connect to connectors on the garment (e.g., female connectors), but rather connect to connectors on the harness 310, to be described with greater detail in reference to FIG. 5. In this optional embodiment, the straps 202, 204, 206 and 208 are releasably connected to the garment 101 via hook and loop connectors such as Velcro® Brand which is disposed on the strap potions, on the section of the strap that threads through loops 302, 304, 306 and 308, and connected to the back of the harness 314 as shown in FIG. 5. In optional embodiments, the connectors are strong bar tracks, where no garment is attached, and the user can where the harness alone.

Referring now to FIG. 4, the garment/harness configuration is shown generally at 400 in which the pouch is shown with the garment, fully connected.

Referring now to FIG. 5, a back portion of the harness 310 is shown generally at 300. The harness 310 comprises a “X” shaped support structure 502 and a rhomboid webbing 504. The webbing 504 may be stitched on top of the support structure 502 and connect to the pouch via shoulder straps. As shown, back connectors 514 and 516 are configured for releasable connection to the pouch 114, as are releasable connectors 518 and 520. Hook and loop connectors 506 and 508 are configured to mate with either the hook portion, or the loop portion, attached to the garment, the connectors configured to hold the pouch in place on a top portion. Hook and loop connectors 510 and 512 are configured mate with either the hook portion, or the loop portion, attached to the garment, the connectors configured to hold the pouch in place on a bottom portion.

Specific configurations and arrangements of the invention, discussed above with reference to the accompanying drawing, are for illustrative purposes only. Other configurations and arrangements that are within the purview of a skilled artisan can be made, used, or sold without departing from the spirit and scope of the invention. For example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise

The order or sequence of any process or method steps may be varied or re-sequenced according to alternative embodiments. Other substitutions, modifications, changes and omissions may be made in the design, operating conditions and arrangement of the embodiments without departing from the spirit and scope of the methods and systems described herein.

What is claimed is:

1. An apparatus for carrying an animal, the apparatus comprising
a wearable garment having at least a first connector element and a second connector element attached thereto;
a pouch having at least a third connector element and a fourth connector element attached to a first and a second support portion, each of the third and the fourth connector elements configured for releasable connection to the first and second connector elements of the garment;
wherein the pouch comprises a internal pocket and a bottom aperture.

2. The apparatus of claim 1, wherein the first and the second connector elements comprises male portions, and the third and fourth connector elements comprise female portions for coupling and decoupling with the male portions using an interference, press, snap, or friction fit.

3. The apparatus of claim 1, wherein the first and the second support portions each comprise an adjustable slide, each of the adjustable slides being configured to alter the length of the support portions.

4. The apparatus of claim 1, wherein the first and second connector elements are disposed on a lower portion of an interior of the garment.

5. The apparatus of claim 1, wherein the pouch comprises:
an internal space having a first diameter sized for the body of an animal;
a lower aperture having a second diameter that is smaller than the first diameter, and is sized for a tail of an animal.

6. The apparatus of claim 1, wherein the first and second support portions comprise first and second straps connected to the pouch on each corner of the pouch.

7. The apparatus of claim 1, wherein the garment comprises fifth and sixth connector elements attached thereto, and wherein the pouch has seventh and eighth connector element and a third and fourth support portion, each seventh and eighth connector elements configured for releasable connection to the fifth and sixth connector elements.

8. The apparatus of claim 1, wherein the pouch further comprises a hinged flap.

9. A harness for carrying an animal, the harness comprising:
a support structure having a first and second strap, each of the first and the second strap having connectors at each end; and
a pouch having at least two support portions having respective connectors at each end, wherein the support stricture connectors are releasably connected to respective ones of the support structure;
wherein the pouch comprises a internal pocket and a bottom aperture.

10. The harness of claim 9, wherein the support structure comprises an x-shaped support structure and a rhomboid webbing, wherein the rhomboid webbing is disposed on the support structure.

11. The harness of claim 9, wherein the first and the second straps comprise at least a first and second back connector configured for attachment to a garment.

12. The harness of claim 9, wherein straps each comprise an adjustable slide, the adjustable slides configured to alter the length of the support portion.

13. The harness of claim 9, wherein the pouch comprises:
an internal space having a first diameter sized for the body of an animal;
a lower aperture having a second diameter that is smaller than the first diameter, and is configured and sized for a tail of an animal.

14. The harness of claim 9, wherein the first and second support portions comprise first and second straps connected to the pouch on each of four corners of the pouch.

15. The harness of claim 9, wherein the connectors on the straps comprise at least at least four connector elements attached thereto; and wherein the pouch comprises at least four connector elements attached thereto, configured for respective connection.
